(19) United States
(12) Patent Application Publication
(10) Pub. No.: US 2005/0052668 A1
(43) Pub. Date: Mar. 10, 2005

(54) Color adjusting method, program and program-recorded medium

(75) Inventor: Toru Hoshino, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 10/911,266

(22) Filed: Aug. 4, 2004

(30) Foreign Application Priority Data
Aug. 13, 2003 (JP) JP2003-292926

(51) Int. Cl. H04N 1/56; H04N 1/60

(52) U.S. Cl. 358/1.9; 358/518; 358/523; 358/504

(57) ABSTRACT

A color adjusting method including: creating a first color profile for each of a first and a second image outputting apparatuses, based on values obtained by measuring a color chart; creating a second color profile based on the first color profile; and adjusting by using the second color profile in such a manner that an output color of the second image outputting apparatus matches to that of the first image outputting apparatus. The color adjusting method further including: adjusting lightness; and adjusting chroma by changing the values of the predetermined color system so as to adjust the chroma in response to the ratio of the lightness before to the lightness after the adjusting lightness step; wherein, the second color profile is created, based on the values having been adjusted in the adjusting lightness step and in the adjusting chroma step.

### BACKGROUND OF THE INVENTION

The present invention relates to a color adjusting method for color matching of the images outputted by a plurality of image outputting apparatuses, a program for allowing the color adjusting method to be executed by a computer, and a computer-readable information recording medium for recording the program. It relates particularly to the color adjusting method for color adjustment between a printing machine and a proof color printer to improve the color reproduction precision of the digital color proof of printer matters, a program for allowing the color adjusting method to be executed by a computer, and a computer-readable information recording medium for recording the program.

In recent years, there have been an increasing number of cases where a digital color proof of printed material is outputted and proofreading is performed before printed material is printed. To ensure quick reliable proofreading, it is necessary to enhance color reproducibility of color proofs. To put it another way, the output color of the proof color printer for color proof outputting must be properly adjusted to the output color of the printing machine. Otherwise, accurate evaluation of the color development of printed material will become difficult.

In the color matching between the proof color printer and printing machine, color reproduction of C (cyan), (M) magenta, (Y) yellow and K (black) as fundamental colors can be achieved with preferable precision. For the R (red), G (green) and B (blue) as secondary colors, or the black or similar colors consisting of three C, M and Y colors or four C, M, Y and K colors, however, it has been difficult to achieve high precision adjustment of these colors to the output colors of the printing machine. To solve this problem, an attempt has been made to improve the color reproduction precision, using a method adopting the color management system by the device color profile disclosed in the following Patent Document 1.

The color adjusting method disclosed in this Patent Document 1 can be described as follows: According to the claim 1 of this document, the first step is to create a device color profile containing the CMYK→L*a*b* LUT incorporating the values of the (L*a*b*) color system in response to the combinations of the C, M, Y and K; and the L*a*b*→CMYK LUT incorporating the values of the CMYK in response to the combinations of the color system values, for each of the printing machine and proof color printer. Based on these two device color profiles, the second step is to create a device-link color profile incorporating the values of CMYK in the proof color printer in response to the combinations of CMYK of the printing machine. Then the values of CMYK of the image data is transformed by the device-link color profile in such a way that the output conforming to the color of the printing machine can be obtained. This is the aforementioned color adjusting method according to the Patent Document 1. When creating a device color profile, a gradation correction curve on K is created based on the CMYK→L*a*b* LUT of the printing machine and proof color printer. This is followed by the step of obtaining the combinations of the three CMY for K=0 in the proof color printer, with respect to each of the combinations of three CMY colors for K=0 in the printing machine. Then the output value of three CMY colors in the device color profile is obtained from the combination of three CMY colors for K=0 in the proof color printer corresponding to each of the combinations of the three CMY colors for K=0 in the printing machine. At the same time, the output value of K is obtained by transformation according to the gradation correction curve. This is the color adjusting method disclosed in this Patent Document 1. To find the device color profile, the color patch containing many combinations covering the entire color space of the CMYK are outputted from the printing machine and proof color printer, and the device color profile is obtained from the L*a*b* color value of each color patch measured by the calorimeter.

According to claim 3 of this Patent Document, when creating a device-link color profile, a gradation correction curve on K is created based on the CMYK→L*a*b* LUT of the printing machine and proof color printer. This is followed by the step of obtaining the initial values of the CMYK of the proof color printer for each of the combinations of the CMYK of the printing machine, using the CMYK→L*a*b* LUT of the printing machine and L*a*b*→CMYK LUT of the proof color printer. The next step is to obtain the values for the three CMY colors of the proof color printer, using the value K obtained by the transformation of these initial values and the correction thereof according to the gradation correction curve. The aforementioned color adjusting method is arranged in such a manner that that the values for the fundamental colors of the three CMY colors and the value K obtained by correction according to the gradation correction curve will be the output values of the device-link color profile.

[Patent Document 1] Official Gazette of Japanese Patent Tokkai 2002-330302 (Paragraph [0027], “What is Claimed” in the Specification)

However, there was a problem that, when the aforementioned method was applied to the output of the color proof of the image outputted onto uncoated paper or similar printing paper having much light-scattering, the color outputted and reproduced on the color proof was less dark than that of the actual printed material. This problem was solved by adjusting the lightness to provide correction so that the color would be darker.

In the prior art, when such correction was made, for example, in the L*a*b* color system, the lightness L* was adjusted, with the values of a* and b* expressing the chroma kept at constant levels. For such a color as blue where the L* was low and the chroma was high, a dark color with high chroma was outputted; therefore, it was not possible to perform appropriate matching of the color with that of printed material.

In view of the prior art described above, it is an object of the prevent invention is to provide a color adjusting method capable of high-precision color matching with a plurality of image outputting apparatuses by correcting the chroma as well as the lightness of the output color, a program for allowing the color adjusting method to be executed by a computer, and a computer-readable information recording medium for recording the program.

### SUMMARY OF THE INVENTION

The aforementioned objects can be achieved by the present invention having the following features:

(1) A color adjusting method comprising the steps of:

creating a first color profile for each of a first and a second image outputting apparatuses, based on values for a predetermined color system obtained by measuring a color chart outputted with various combinations of values representing intensities of cyan (C), magenta (M), yellow (Y) and black (K) as fundamental colors, the first color profile including: a first lookup table storing the values of the predetermined color system corresponding to combinations of values for the intensities of the fundamental colors; and a second lookup table storing combinations of values for the intensities of the fundamental colors corresponding to the values of the predetermined color system;
creating a second color profile based on the first color profile of the first and the second image outputting apparatuses, the second color profile storing combinations of values for intensities of the fundamental colors of the second image outputting apparatus, corresponding to combinations of values for intensities of the fundamental colors of the first image outputting apparatus; and
adjusting by using the second color profile in such a manner that an output color of the second image outputting apparatus matches to that of the first image outputting apparatus;
wherein the color adjusting method further comprising the steps of:
adjusting lightness expressed by values of the predetermined color system obtained from the first lookup table of the first image outputting apparatus; and
adjusting chroma by changing the values of the predetermined color system so as to adjust the chroma in response to the ratio of the lightness before to the lightness after the adjusting lightness step;
wherein, the second color profile is created, based on the values of predetermined color systems having been adjusted in the adjusting lightness step and in the adjusting chroma step.

(2) The color adjusting method described in (1), wherein the predetermined color system is L*a*b* color system, and the adjusting chroma step comprising:
transforming values of the L*a*b* color system before adjustment in the adjusting lightness step, into values of XYZ color system;
transforming L* value of the L*a*b* color system after the adjustment in the adjusting lightness step, into Y value of the XYZ color system;
correcting, for the purpose of adjusting the chroma, the values of X and Z of the XYZ color system before the adjustment in the adjusting lightness step, in response to the ratio of the value Y before the adjustment to the value Y after the adjustment; and
transforming the corrected values X and Z and value Y after the adjustment, into values of the L*a*b* color system.

(3) The color adjusting method described in (1) wherein the aforementioned color system is a L*a*b* color system, and the chroma adjusting step contains the steps of:
transforming values of the L*a*b* color system before adjustment in the adjusting lightness step, into values of XYZ color system;
transforming values of XYZ color system before the adjustment obtained, into values of RGB color system;
transforming L* value of the L*a*b* color system after the adjustment in the adjusting lightness step, into Y value of the XYZ color system;
correcting, for the purpose of adjusting the chroma, the values the RGB color system before the adjustment in the adjusting lightness step, in response to the ratio of the value Y before the adjustment to the value Y after the adjustment;
transforming the corrected values of the RGB color system
   into values of the XYZ color system; and
transforming the transformed values of the XYZ color system into values of the L*a*b* color system.

(4) The color adjusting method described in any one of (1) through (3) wherein different types of paper are used between the first and second image outputting apparatuses.

(5) The color adjusting method described in any one of (1) through (4) wherein the first image outputting apparatus is a printing machine, and the second image outputting apparatus is a proof color printer for outputting the color proof for proofreading.

(6) A program for allowing a computer to execute the color adjusting method described in any one of (1) through (5).

(7) A computer-readable information recording medium for recording the program described in (6).

The invention described in (1) allows the lightness as well as chroma of the output color to be adjusted in response to the lightness adjusting amount, when creating the second color profile used for color adjustment, thereby ensuring high-precision color adjustment among a plurality of image outputting apparatuses.

Further, according to the invention described in (2) and (3), the value in predetermined color system obtained by measurement of a color chart is adjusted after having been transformed into a value of another color system suited for adjustment of the lightness and chroma. Further, the invention described in (3) provides high-precision color matching equivalent to human color recognition, and improves color reproduction precision of the shadow portion in particular.

The invention described in (4) provides color matching by adjusting the lightness and chroma, when there are differences in the output color resulting from differences in the type of paper including differences in the level of scattering.

### BRIEF DESCRIPTION OF THE DRAWINGS

FIG. 1 is a block diagram representing an example of the schematic configuration of an image output system for implementing the first embodiment of a color adjusting method of the present invention;

FIG. 2 is a functional block diagram representing an example of the schematic configuration of an image transforming apparatus contained in the image output system for implementing the first embodiment of a color adjusting method of the present invention;

FIG. 3 is a block diagram representing an example of the hardware configuration of an image transforming apparatus contained in the image output system for implementing the first embodiment of a color adjusting method of the present invention;

FIG. 4 is a drawing representing an example of the schedule configuration of a color chart used in the image output system for implementing the first embodiment of a color adjusting method of the present invention;

FIG. 5 is a flowchart representing an example of processing implemented by a first embodiment of the color adjusting method of the present invention;

FIG. 6 is a flowchart representing an example of processing implemented by the first embodiment of the color adjusting method of the present invention;

FIG. 7 is a flowchart representing an example of processing implemented by the first embodiment of the color adjusting method of the present invention;

FIG. 8(a), (b) are charts representing an example of the lightness correction curve used in the first embodiment of the color adjusting method of the present invention; wherein FIG. 8(a) shows an example of this lightness correction curve while FIG. 8(b) shows the relationship between the L* input value and L* output value for creating this lightness correction curve;

FIG. 9 is a functional block diagram representing an example of the schematic configuration of an image transforming apparatus contained in the image output system for implementing the second embodiment of a color adjusting method of the present invention; and

FIG. 10 is a flowchart representing an example of processing implemented by the second embodiment of the color adjusting method of the present invention.

### DETAILED DESCRIPTION OF THE PREFERRED EMBODIMENT

Referring to the drawings, the following describes the details of an example of the embodiment of a color adjusting method of the present invention. The description will refer to each of the first embodiment configured to use the XYZ color system to adjust the lightness (L*) and chroma representing by the values in the L*a*b* color system obtained by measurement of the color chart, and the second embodiment configured to adjust the lightness and chroma in the RGB color system. Here the L*a*b* color system indicates what is described as “a predetermined color system” in the present invention. It should be noted that the “predetermined color system” is not restricted to the L*a*b* color system. Various color systems may be used as appropriate.

Embodiment 1

In the present embodiment, the following describes an image output system for implementing the color adjusting method for adjusting the output colors of the proof color printer as a target of color matching on the printing machine. Here the printing machine represents an example of the “first image outputting apparatus” of the present invention, while the proof color printer indicates an example of the “second image outputting apparatus”.

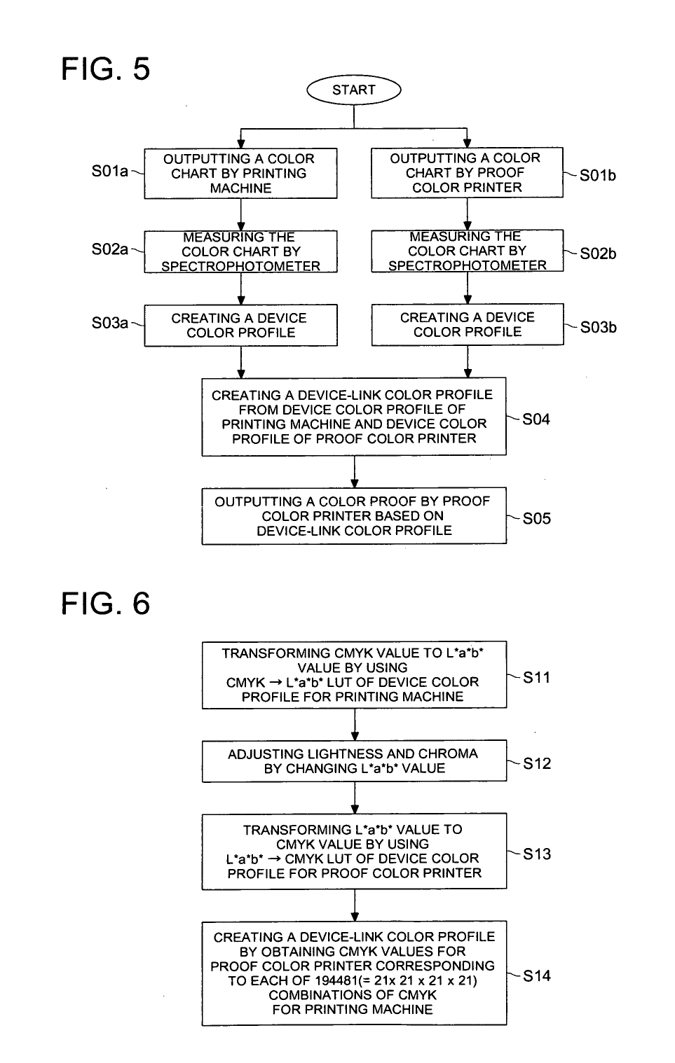

FIG. 5 shows a schematic view showing the overall flow of the processing performed in the image outputting system. The printing machine outputs the color chart (S01a). The colors on this color chart are measured by a spectrophotometer (S02) to get the values of the L*a*b* color system (called L*, a*, b*; L*a*b* value) (S02a). Based on this L*a*b* value, a device color profile of the printing machine is created (S03a). Similarly, a color chart is outputted by the proof color printer (S01b), and the colors of this color chart are measured by the spectrophotometer to get the L*a*b* value (S02). Based on this L*a*b* value, the device color profile of the proof color printer is created (S03b).

Then a device-link color profile is created from the device color profile of the printing machine and that of the proof color printer (S04). Based on this device-link color profile, a color proof is outputted by the proof color printer (S05).

The color adjusting method of the present embodiment is characterized by applying processing of appropriate correction of the lightness and chroma of the reproduced color in the phase of creating the device-link color profile in the aforementioned processing (S04). The details of the aforementioned device color profile and device-link color profile will be described later.

(Construction)

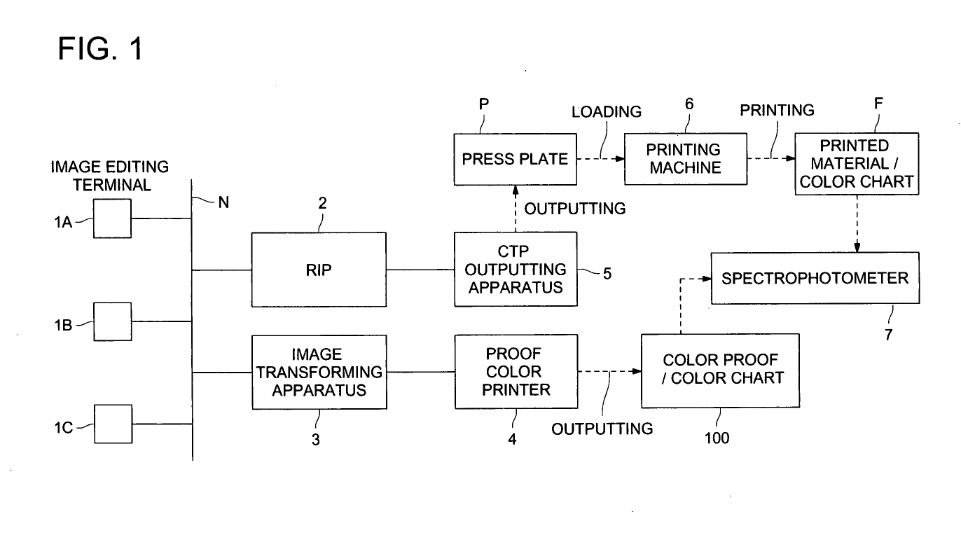

FIG. 1 is a block diagram representing an example of the configuration of an image output system for implementing a color adjusting method of the present invention. As shown in FIG. 1, this image outputting system comprises:
an image editing terminals 1A through 1C as an upstream terminal for editing the image of printed material;
a RIP (Raster Imager Processor) 2
an image transforming apparatus 3 capable of performing various image transforming operations for outputting the color poof of printed material; and
a proof color printer 4 for outputting a color proof or color chart 100. The image editing terminals 1A through 1C and RIP 2 are connected through the network N such as the LAN and the Internet in such a manner as to allow communications.

This image outputting system is provided with a CTP outputting apparatus capable of outputting the data sent from the RIP 2 by forming an image directly on the press plate. The press plate P outputted by this CTP outputting apparatus 5 is mounted on the printing machine 6 to perform processing of printing, thereby outputting the printed material F. Further, the printing machine 6 can also output the color chart (numeral 100 used similarly).

A spectrophotometer 7 is provided, which is capable of measuring the L*a*b* value of the L*a*b* color system for the color of the output item (color chart 100, F in particular) outputted by the proof color printer 4 and printing machine 6. In the configuration shown in FIG. 1, an independent spectrophotometer 7 is provided. It may be built in the proof color printer 4 or printing machine 6. Further, measurement by the spectrophotometer 7 may be performed manually (especially when provided independently) or automatically (especially when built inside).

(Configuration of Image Editing Terminal)

The image editing terminals 1A through 1C consists of a computer terminal loaded with the application software for editing the image data of the printed material by separating it into a plurality of color plates using the DTP technique, and is provided with such an image inputting device as an image scanner, in addition to the computer proper, keyboard and monitor (not illustrated) Normally a plurality of such image editing terminals are provided (three image editing terminals 1A through 1C are provided in the present embodiment, but one image editing terminal or as many image editing terminals as required may be provided). The image data edited by the image editing terminals 1A through 1C is normally sent to the RIP 2 through the network N; however, it may be sent to both the RIP 2 and image transforming apparatus 3.

(RIP Configuration)

The RIP 2 consists of a server or the like that functions as a processor that receives the image data as a basis of an electronic printing plate of printed matter edited by the image editing terminals 1A through 1C, through the network N, and transforms it into a bit map, while scanning the character and image data. It provides field sequential generation of the dot image data of each of C (cyan), M (magenta), Y (yellow) and K (black) as fundamental colors. When generating the image data outputted by the proof color printer, CMYK image data can be generated before dot formation.

(Configuration of Image Transforming Apparatus)

The image transforming apparatus 3 is an information processing apparatus incorporating a predetermined operation program, and consists of a computer proper, keyboard and monitor, as usual. This image transforming apparatus 3 obtains the CMYK image data generated by the RIP 2 through the network N, and performs color transformation of the CMYK value so that it is outputted by the proof color printer 4. It is so arranged as to create a dot image data after this color transformation. This image transforming apparatus 3 is further arranged to perform processing of color adjustment in the present embodiment, as will be described later.

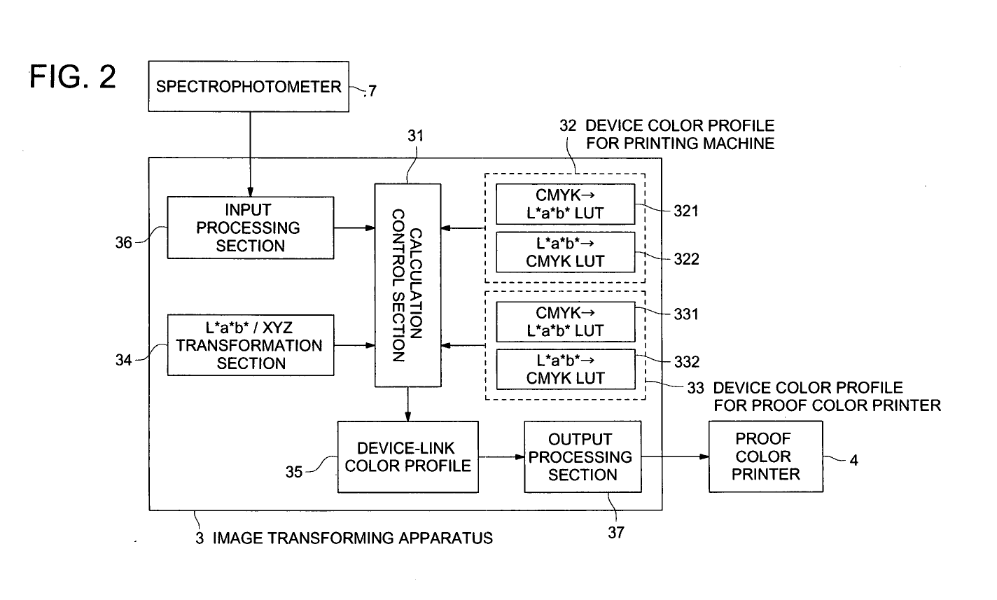

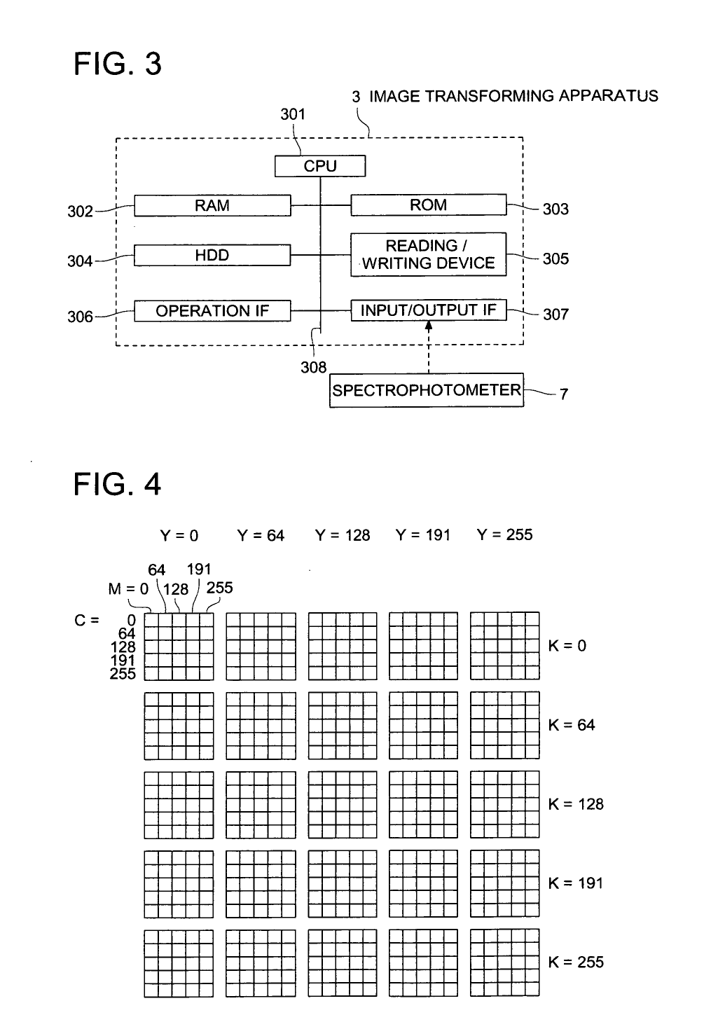

Referring to FIGS. 2 and 3, the following describes the details of the image transforming apparatus 3. Here FIG. 2 is a function block diagram representing the functional configuration of the image transforming apparatus 3, and FIG. 3 is a block diagram representing the hardware configuration of the image transforming apparatus 3 for performing such an operation.

(Functional Configuration of Image Transforming Apparatus)

As shown in FIG. 2, the image transforming apparatus 3 contains:
a calculation control section 3;
a device color profile 32 of the printing machine 6;
a device color profile 33 of the proof color printer 4;
a L*a*b*/XYZ transforming section 34;
a device-link color profile 35;
an input processing section 36 for performing input processing of the result of measurement by the spectrophotometer 7; and
an output processing section 37 for performing the processing of creating further dot images through color transformation of the CMYK image data by the device-link color profile 35.

The calculation control section 31 performs various calculations and control of various parts of the apparatus. Especially it performs processing of creating the device color profiles 32 and 33, and device-link color profile 35.

The device color profile 32 consists of various lookup tables (hereinafter abbreviated as “LUT”) defining the color output characteristics of the printing machine 6. This device color profile 32 contains:
a CMYK→L*a*b* LUT 321 incorporating the L*a*b* values corresponding to various combinations of the intensities of the output of the C, M, Y and K as fundamental colors by the printing machine 6; and
a L*a*b*→CMYK LUT 322 storing the combinations of the intensities of the output of the C, M, Y and K by the printing machine 6 corresponding to various L*a*b* values.

Similarly, the device color profile 33 contains:
a CMYK→L*a*b* LUT 331 incorporating the L*a*b* values corresponding to various combinations of the intensities of the output of the C, M, Y and K as fundamental colors by the proof color printer 4; and
a L*a*b*→CMYK LUT 322 storing the combinations of the intensities of the output of the C, M, Y and K by the proof color printer 4 corresponding to various L*a*b* values.

Here the inverter control units 32 and 33 are what is called the first color profile in the present invention. The CMYK→L*a*b* LUTs 321 and 331 indicates the first lookup table, while the L*a*b*→CMYK LUTs 322 and 332 shows the second lookup table.

The CMYK→L*a*b* LUTs 321 and 331 are used to transform the C, M, Y and K values into L*a*b* values. The L*a*b*→CMYK LUTs 322 and 332 are used to transform the inputted L*a*b* values into the C, M, Y and K values. In the entire color space of the L*a*b* color system, the color reproducible range of the color mixture of the C, M, Y and K by the proof color printer 4 and printing machine 6 or is limited. Thus, a plurality of types of mapping methods obtained by variously changing the method of mapping the all-color space of L*a*b* within the CMYK color reproducible range are stored in the L*a*b*→CMYK LUTs 322 and 332, so that it can be used on an selective basis in response to the type of the input device. This is the general configuration. The LUT creation method will be described later.

The L*a*b*/XYZ transforming section 34 stores a transformation formula used for transforming the values of the L*a*b* color system into the values of the XYZ color system; and a transformation formula used for transforming the values of the XYZ color system into the values of the L*a*b* color system. Such transformation is carrying out when the calculation control section 31 substitutes numerals into this transformation formula. The following formula 1 is the one for transforming the values of L*a*b* color system into the values of XYZ color system. Formula 2 is the one for transforming the values of XYZ color system into the values of L*a*b* color system.
Yd=(L*+16)/116
Xd=a*/500+Yd
Zd=Yd−b*/200
X/X0=Xd³ (Xd≧0.206893)=(Xd−16/116)/7.787 (otherwise)
Y/Y0=Yd³ (Yd≧0.206893)=(Yd−16/116)/7.787 (otherwise)
Z/Z0=Zd³ (Zd≧0.206893)=(Zd−16/116)/7.787 (otherwise) (Formula 1)
Xd=(X/X0)^{1/3} (X/X0>0.008856)=(X/X0)×7.787+16/116 (otherwise)
Yd=(Y/Y0)^{1/3} (Y/Y0>0.008856)=(Y/Y0)×7.787+16/116 (otherwise)
Zd=(Z/Z0)^{1/3} (Z/Z0>0.008856)=(Z/Z0)×7.787+16/116 (otherwise)
L*=Yd×116−16
a*=500×(Xd−Yd)
b*=200×(Yd−Zd) (Formula 2)

The device-link color profile 35 is an LUT for matching the output colors between devices, and stores the C, M, Y and K four-color combinations of the proof color printer 4 with respect to combinations of the C, M, Y and K as four fundamental colors outputted from the printing machine 6. This device-link color profile 35 is created based on the device color profiles 32 and 33 (details of work to be described later). The colors of the CMYK image data are transformed by the device-link color profile 35 created in this manner, and the colors in the color proof output mode are adjusted. The device-link color profile 35 indicates what is called the second color profile in the present invention.

The input processing section 36 is an input interface for performing processing of inputting the measurement (L*a*b* value) by the spectrophotometer 7 of the color chart F 100 outputted by the printing machine 6 and proof color printer 4. This input of the measurement may be given directly through wired or wireless connection, or may be manually inputted by a user. It is also possible to make such arrangements that a means for recording the measurement data from the spectrophotometer 7 on a predetermined recording medium and the measurement data may be inputted through the recording medium.

The output processing section 37 uses the created device-link color profile 35 to provide color transformation of the image data of CMYK, and performs dot formation and processing of sending the halftone image data to the proof color printer 4.

(Hardware Configuration of the Image Transforming Apparatus)

Referring to the block diagram of FIG. 3, the following describes the hardware configuration of the image transforming apparatus 3 having the functional configuration stated above.

The image transforming apparatus 3 contains:
a CPU 301 for performing processing of calculation and control in conformity to a predetermined program;
a RAM 302 a main memory for expanding the programs executed by the CPU 301 and various data sets;
a ROM 303 for storing the programs such as BIOS;
a hard disk drive (HDD) 304 for storing such an operation program as OS, and various data sets, as well as application software;
a reading/writing device 305 for reading the data recorded on the information recording medium and for writing data;
an operation IF 306 for input processing of the operation signal sent from such operation means as a keyboard and mouse; and
an input/output IF 307 for inputting and outputting various data sets. The input/output IF 307, in particular, performs input processing of the results of measurement by the spectrophotometer 7 (FIG. 2). It is also provided with the display interface for sending image data to the monitor.

The image transforming apparatus 3 copies the program stored in the ROM 303 and HDD 304, into the RAM 302, and the CPU 301 executes the program copied into the RAM 302, whereby the functions of the present invention are performed. This program is stored in advance in such an information recording medium as a disk, CD-ROM and DVD-ROM, and is installed by the reading/writing device 305 so that the program is run on the image transforming apparatus 3. It is also possible to use the program by downloading from the server on the network such as the Internet or LAN.

The CPU 301 is used for overall control of the image transforming apparatus 3 as well as individual control of each portion; it is also used for processing of calculation. Together with various programs expanded on the RAM 302, it constitutes the calculation control section 31.

The HDD 304 is provided with a storage area as a buffer for temporarily storing the halftone image data from the RIP 2 and adjusting the intervals timed for processing; a storage area for storing the device color profiles 32 and 33 and device-link color profile 35; and a storage area for storing the formulas 1 and 2 of the L*a*b*/XYZ transforming section 34. It is also possible to make such arrangements that the device color profiles 32 and 33, device-link color profile 35, and the formulas 1 and 2 of the L*a*b*/XYZ transforming section 34 are stored in the ROM 303.

The reading/writing device 305 can be any appropriate one conforming to the application requirements and system configuration, including a floppy (trademark) disk drive (FDD) for reading and writing the floppy (trademark) disk or a CD(DVD)-ROM drive for reading and writing the CD-ROM (and/or DVD-ROM).

The input/output IF 307 performs the functions as the input processing section 36 and output processing section 37 in FIG. 2. It also performs input processing of the CMYK image data sent from the RIP 2.

(Configuration of Proof Color Printer)

The following describes the proof color printer 4 for outputting a color proof as a proof of printed material. The description will be simple because the proof color printer 4 used in the present embodiment consists of known components.

The proof color printer 4 performs processing of exposure by allowing the magenta coloring layer (layer M) of the photosensitive material to be exposed to the red (R) light, the cyan coloring layer (layer C) of the photosensitive material to be exposed to the green (G) light, and the yellow coloring layer (layer Y) of the photosensitive material to be exposed to the blue (B) light. The proof color printer 4 also applies processing of development to form color images. Processing of exposure to these R, G and B beams of light is applied in a dot sequential method for each pixel. It may be noted that silver halide photosensitive material is commonly used as the photosensitive material.

The proof color printer 4 outputs the color chart 100 based on the halftone image data, sent from the output processing section 37 of the image transforming apparatus 3, separated into the C, M, Y and K (and special color) as fundamental colors.

(How to Create a Device Color Profile)

The following describes how to create the device color profile 32 of the printing machine 6 and the device color profile 33 of the proof color printer 4. They are created by the calculation control section 31 of the image transforming apparatus 3.

(How to Create the CMYK→L*a*b* LUT)

The CMYK→L*a*b* LUTs 321 and 331 are created based on the L*a*b* value of each color patch obtained by using spectrophotometer 7 to measure the color chart F 100 equipped with many color patches to be outputted by combinations of four colors over the entire CMYK space. The CMYK→L*a*b* LUTs 321 and 331 are also created in the same manner, so an example of creating only the CMYK→L*a*b* LUT 321 will be described.

In the first place, the range from minimum value 0 to the maximum value 255 is divided into four equal parts for each of C, M, Y and K. The printing machine 6 outputs the color chart F, shown in FIG. 4, provided with color patches having combinations of C×M×Y×K: 5×5×5×5=625, where consideration is given to five phases of 0, 64, 128, 191 and 255. Then each color patch of this color chart F is measured by the spectrophotometer 7 sequentially to get the L*a*b* value. This description is illustrated by the processes of the S01a and S02a in the flowchart of FIG. 5.

The above operation is followed by the step of expanding the number of the combinations of C, M, Y and K from 5×5×5×5 to 9×9×9×9. For each of the C, M, Y and K, take the P1 as the value in the range from 0 through 64, P2 as the value in the range from 64 through 128, P3 as the value in the range from 128 through 191, and P4 as the value in the range from 191 through 255. A value of any one of P1 through P4 can be a mid-point of each section. Further, the L*a*b* value corresponding to any one of the values P1 through P4 can be calculated from the L*a*b* value obtained by measuring the color patches of the aforementioned 625 combinations, and five combinations of C, M, Y and K values are expanded into nine combinations. This procedure provides the CMYK→L*a*b* LUT having the L*a*b* values corresponding to 6561 input points (C×M×Y×K: 9×9×9×9=6561). A specific method of working out the L*a*b* values corresponding to the P1 through P4 is disclosed in the Official Gazette of Japanese Patent Tokkai 2002-330302 by the present inventors, for example.

(How to Create L*a*b*→CMYK LUT)

The following describes how to create the L*a*b*→CMYK LUTs 322 and 332. In this case as well, the description will be given only to the L*a*b*→CMYK LUT 322. The method of creation is disclosed in details in the aforementioned document by the present inventors. It is composed of four processing steps.

In the fist step, the L*a*b* value corresponding to C×M×Y×K: 9×9×9×9 of the CMYK→L*a*b* LUT 321 is transformed into the L*a*b* value corresponding to the C×M×Y: 9×9×9. To put it another way, the 4D data is transformed into the 3D data. This is done by getting the value K added to enhance the gray component consisting of the minimum value of the CMY, and by adding this value K to each of the combinations of C, M and Y, whereby the L*a*b* value in this case is defined as the L*a*b* value corresponding to each of the combinations of C, M and Y.

In the second step, the 3D data of C×M×Y: 9×9×9 is used to get the L*a*b*→CMYK LUT 322. For this purpose, the value of C×M×Y: 9×9×9=729 is assumed as a grid point and the 3D CMY space (called the CMY space) is split. This CMY space is mapped onto the 3D space of the L*a*b* color system. The image in the CMY space mapped onto the space of the L*a*b* color system will be called the CMY space image. Further, the image, formed by the aforementioned mapping, on the grid point of the L*a*b* color system will be called the grid point image.

Take a target value T′ (not matched with the grid point image) in the CMY space image. The target value T′ is present in the area R′ in the CMY space image split in a grid form. The area R′ has eight grid point images as apexes. In this case, the point T of the CMY space corresponding to the target T′ is estimated to be present in the area R enclosed by right grid points corresponding to the eight grid point images. The position of the point T in the area R can be obtained by processing of convergence calculation based on the correspondence between the CMY space and L*a*b*color system. This processing of convergence calculation is carried out by stepwise splitting of the area R and area R′ and by determining which of the split areas in each phase contains point P and target value T′. The aforementioned dependency on the processing of convergence calculation is due to the fact that a transformation formula for expressing the reverse transformation is not known, whereas the transformation formula from the CMY coordinate system to the L*a*b* color system is already known.

When the target value T′ in the space of the L*a*b* color system is outside the CMY space image (i.e. color reproduction range), this target value T′ is moved to the boundary position of the CMY space image in the direction of achromatic color, and this boundary position is defined as the target value for color reproduction. Thus, the color that cannot be precisely defined is outputted as the color as closest as possible to the intended color.

This calculation provides C, M and Y values corresponding to 35937 (=L*a*b*: 33×33×33) LUT input points. In this case, L* is defined within 0 through 100 a* within—127 through 128, and b* within—127 through 128.

In addition to the aforementioned convergence calculation, it is also possible to use the interpolation method described in the Specification of Patent No. 2895086 by the present inventors.

In the third step, the value K is calculated, based on the C, M and Y values corresponding to the LUT input points of L*×a*×b*: 33×33×33 obtained in the second step.

In the last fourth step, the C, M, Y and K values corresponding to each input point are obtained, based on the C, M and Y values corresponding to the LUT input points of L*×a*×b*: 33×33×33 obtained in the second step, and the value K obtained in the third step.

(Configuration of Device-Link Color Profile and the Method of Creating the Same)

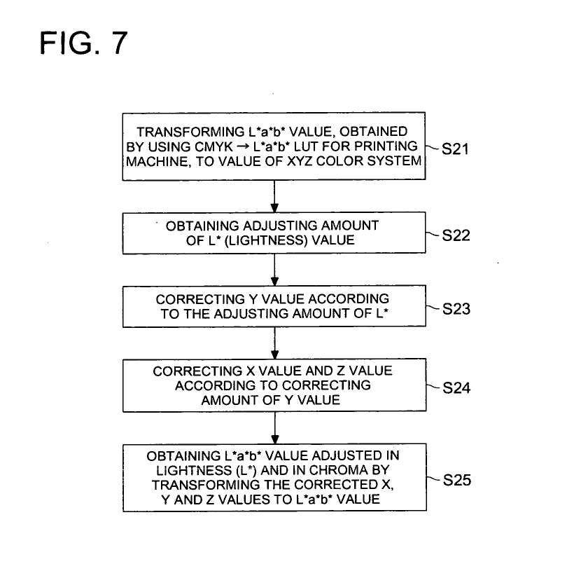

Referring to the flowchart shown in FIGS. 6 and 7, the following describes the device-link color profile 35 created according to the color adjusting method of the present invention and the method of creating the same. The flowchart shown in FIG. 6 shows the overall flow of the processing of creating the device-link color profile 35 according to the present invention. The flowchart of FIG. 7 shows the specific flow related to the adjustment of the lightness and chroma in the processing of creation in FIG. 6. Processing given in each step in the flowcharts of FIGS. 6 and 7 is carried out by the calculation control section 31 of the image transforming apparatus 3.

The device-link color profile 35 of the present invention is configured as a 4D input/4D output LUT for defining the output C, M, Y and K values of the proof color printer 4, corresponding to 194481 (=C×M×Y×K: 21×21×21×21) input points related to the output colors of the printing machine 6.

Thus, each of C, M, Y and K ranges (each 0 through 255) of the printing machine 6 is divided 20 equal parts in advance, and each 21 points are combined to determine 194481 (=C×M×Y×K: 21×21×21×21) input points. To put it more specifically, 0, 12.75, 25.5, 38.25, 51, 63.75, 76.5, 89.25, 102, 114.75, 127.5, 140.25, 153, 165.75, 178.5, 191.25, 204, 216.75, 229.5, 242.25 and 255 are taken in account as input points of each of the C, M, Y and K.

Using the CMYK→L*a*b* LUT 321 of the device color profile 32 of the printing machine 6, the calculation control section 31 transforms one point of the 194481 combinations of C, M, Y and K into the L* value, a* value and b* value (S11).

The values obtained from the transformation in Step S11 are modified as appropriate to adjust the lightness and chroma expressed by L* value, a* value and b* value (S12). It is commonly known that modification of L* value is equivalent to adjustment of lightness, and modification of the a* and b* values is equivalent to adjustment of chroma. The step of adjusting the lightness and chroma constitutes a characteristic part of the present invention. Its specific configuration will be described later with each other FIG. 7.

The above procedure is followed by the step of transforming the L* value, a* value and b* value having been subjected to adjustment of lightness and chroma, into C, M, Y and K values (S13), using the L*a*b*→CMYK LUT 332 of the inverter control unit 33 of the proof color printer 4. This arrangement determines the combinations of the C, M, Y and K by the proof color printer 4 corresponding to one point in 194481 combinations of C, M, Y and K.

For each of the aforementioned 194481 combinations of C, M, Y and K, the processes of S11 through S13 is are followed to obtain the four C, M, Y and K values of the proof color printer 4. All the results of calculation are organized to create the device-link color profile 35 (S14).

Adjustment of the lightness and chroma shown in the aforementioned S12 will be described with reference to the flowchart of FIG. 7:

Using the aforementioned formula 1 of the L*a*b*/XYZ transforming section 34, the calculation control section 31 calculates the values X/X0, Y/Y0 and Z/Z0 of the XYZ color system from the L* value, a* value and b* value obtained in S11 (S21).

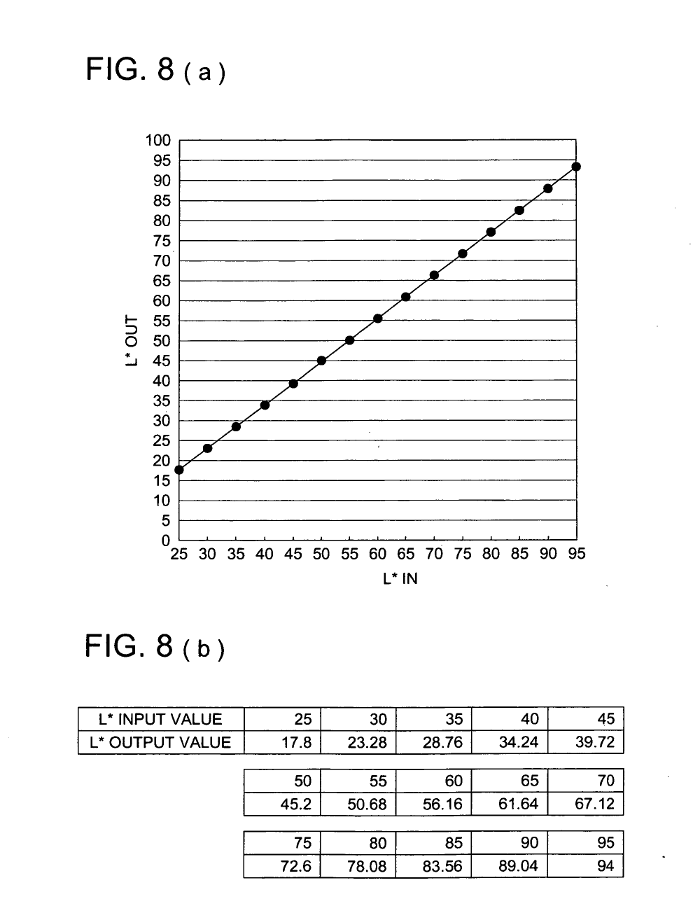

The calculation control section 31 adjusts the L* value showing the lightness (S22). The L* value is adjusted using the lightness correction curve created in advance for the adjustment of lightness. FIG. 8(a) shows an example of the lightness correction curve when uncoated paper is used as printing paper. The L*a*b* value of the maximum lightness (white paper: C=M=Y=K=0%) of the printed material outputted on the printing paper is given as L*=91.1, a*=0.1 and b*=0.5, while the minimum lightness (C=M=Y=K 100%) is given as L*=27.4, a*=1.6 and b*=−0.1. In this case, discrete correction values over the range from lightness L*=27.4 through 91.1 are defined s shown in the Table of FIG. 8(b) according to the known method. The lightness correction curve shown in FIG. 8(a) is a continuous curve gained by connecting coordinate values wherein the *L input value in the Table of FIG. 8(b) is represented on the horizontal axis, and the L* output value on the vertical axis. The lightness correction curve created in this manner is stored in the ROM 303 and HDD 304 of the image transforming apparatus 3.

Lightness is adjusted in S22 by obtaining the L* output value of the lightness correction curve when the L* value of the L*a*b* value obtained in S11 of the flowchart in FIG. 6 is used as an input value. To put it another way, the lightness of adjusted by changing the L* value obtained in S11, into the L* output value.

The above procedure is followed by the step of obtaining the value of Y corresponding to the L* value obtained in S22 (S23). To put it more specifically, the calculation formula Yd=(L*+16)/116 of formula 1 is used to calculate the value Yd₂ of the Yd corresponding to the L*a*b* value and to work out the value Y2/Y0 shown in the following formula.
Y2/Y0=(Yd₂)³ (Yd₂≧0.206893)=(Yd₂−16/116)/7.787 (otherwise) (Formula 3)

Then the value of X (X/Xo) and value of Z (Z/Z0) are adjusted using the value Y/Y0 of Y corresponding to the L* value prior to adjustment of lightness and the value Y2/Y0 corresponding to the L* value subsequent to adjustment (S24). After adjustment, the value of X is assumed as X2/X0, and the value of Y as Z2/Z0. They are each defined as shown in the following formula:
X2/X0=X/X0×{(Y2/Y0)/(Y/Y0)}
Z2/Z0=Z/Z0×{(Y2/Y0)/(Y/Y0)} (Formula 4)

Further, using the formula 2 stored in the L*a*b*/XYZ transforming section 34, the calculation control section 31 converts the value of X (X2/X0), value of Y (Y2/Y0) and value of Z (Z2/Z0) back to the L*a*b* values (S25). For this purpose, Xd′, Yd′ and Zd′ are calculated from the X2/X0, Y2/Y0 and Z2/Z0 using the following formula.
Xd′=(X2/X0)^{1/3} (X2/X0>0.008856)=(X2/X0)×7.787+16/116 (otherwise)
Yd′=(Y2/Y0)^{1/3} (Y2/Y0>0.008856)=(Y2/Y0)×7.787+16/116 (otherwise)
Zd′=(Z2/Z0)^{1/3} (Z2/Z0>0.008856)=(Z2/Z0)×7.787+16/116 (otherwise) (Formula 5)

The Xd′, Yd′ and Zd′ each are substituted into Xd, Yd and Zd of the formula 2 of the L*a*b*/XYZ transforming section 34, and are transformed into L*a*b* values. This arrangement provides the L*′, a*′ and b*′ for which the lightness and chroma are adjusted. The values of L*′, a*′ and b*′ are transformed by the L*a*b*→CMYK LUT 332 to find the C, M, Y and K (S13 in FIG. 6), and to create the device-link color profile 35 (S14 in FIG. 6).

The device-link color profile 35 is created using the L*′, a*′ and b*′ obtained by the process of FIG. 7, whereby the chroma can be adjusted in response to the lightness adjusting amount. In other words, the X2/X0 and Z2/Z0 are calculated (Formula 5) when the ratio (Y2/Y0)/(Y/Y0) between the Y/Y0 dependent only on the lightness prior to adjustment and Y2/Y0 dependent only on the lightness (L*′) subsequent to adjustment is assumed as the coefficient for chroma adjustment. These are used to calculate the a*′ and b*′; therefore, the a*′ and b*′ for determining the chroma are adjusted at the same rate as the lightness (L* value) adjusting amount.

According to the color adjusting method shown in the present embodiment, in addition to adjustment of the lightness, chroma can also be adjusted in response to the adjusting amount. For example, when reproducing such a color as blue having a low L* value and a high chroma, chroma can be set at a low level (the color is set to a light one) in response to the lightness adjusting amount. This arrangement allows the output color of the proof color printer 4 to be matched to the output of the printing machine 6 with high precision.

Embodiment 2

The following describes another embodiment of the color adjusting method according to the present invention: In the aforementioned first embodiment, adjustment of the lightness and chroma in creating the device-link color profile 35 is conducted using values of the XYZ color system. In the meantime, in the present invention, adjustment of the lightness and chroma is conducted using values of another color system—to put it more specifically—values of a RGB color system. This color adjustment method can be implemented in almost the same image outputting system as that of the first embodiment.

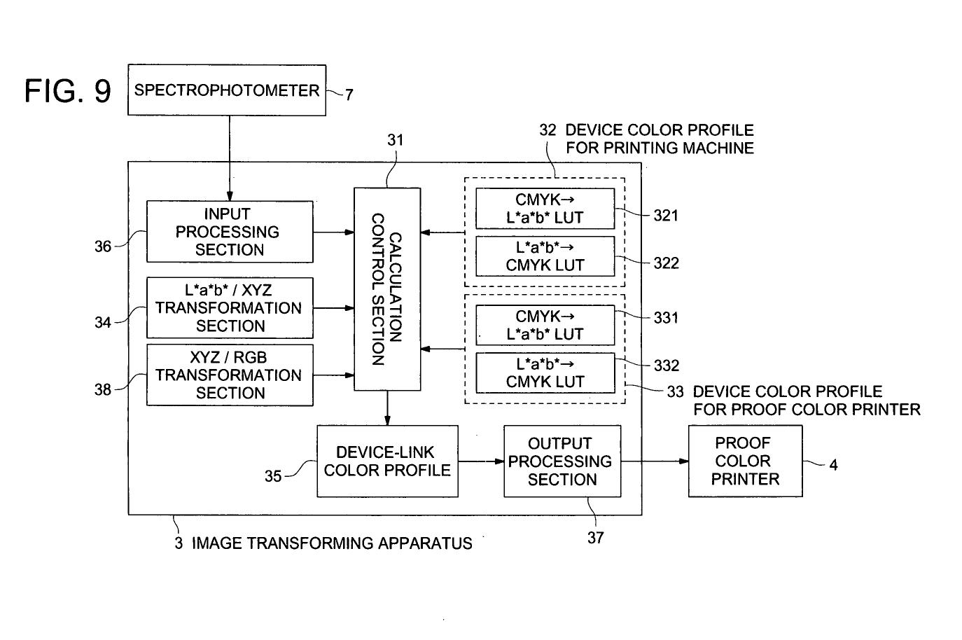

The image transforming apparatus 3 of the image outputting system for applying the color adjustment method of the present embodiment is further provided with an XYZ/RGB transforming section 38 shown in the block diagram of FIG. 9. The XYZ/RGB transforming section 38 stores a transformation formula for transforming the values of the XYZ color system into those of the RGB color system, and a transformation formula for transforming the values of the RGB color system into those of the XYZ color system. This transformation is carried out by the calculation control section 31 substituting numerals into the transformation formulae and making calculations. The following formula 6 is used to transform the values of the XYZ color system into those of the RGB color system, while the formula 7 is used to transform the values the RGB color system into those of the XYZ color system.
R=(X/X0)×0.8951+(Y/Y0)×0.2664+(Z/Z0)×(−0.1614)
G=(X/X0)×(−0.7502)+(Y/Y0)×1.7135+(Z/Z0)×0.0367
B=(X/X0)×0.0389+(Y/Y0)×(−0.0685)+(Z/Z0)×1.0296) (Formula 6)
X/X0=R×0.987+G×(−0.1471)+B×0.16
Y/Y0=R×0.4323+G×0.5184+B×0.0493
Z/Z0=R×(−0.0085)+G×0.04+B×0.9685 (Formula 7)

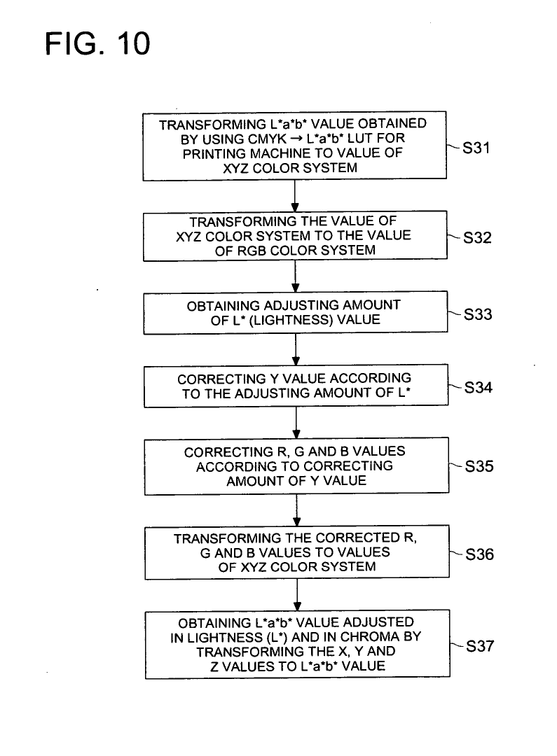

The following describes an example of processing by the color adjusting method according to the present invention: The method for creating the device color profiles 32 and 33 is the same as that described in the first embodiment. The method for creating the device-link color profile 35 is implemented in the same way as that described in the first embodiment, in terms of the processes except for adjustment of the lightness and chroma. Referring to the flowcharts of FIGS. 5 and 6, the following describes the adjustment of lightness and chroma, which is different from that of the first embodiment. FIG. 10 is a flowchart representing the flow of adjustment of the lightness and chroma of the present embodiment. It shows the flowchart to be implemented instead of the flowchart shown in FIG. 7 according to the first embodiment.

In the first place, using the aforementioned Formula 1 stored in the L*a*b*/XYZ transforming section 34, the calculation control section 31 transforms the L* value, a* value and b* value and calculates the values X/X0, Y/Y0 and Z/Z0 of the XYZ color system (S31).

Using the aforementioned Formula 6 stored in the XYZ/RGB transforming section 38, the calculation control section 31 transforms the X/X0, Y/Y0 and Z/Z0 and obtains the values R, G and B of the RGB color system (S32).

Then the calculation control section 31 adjusts the L* value (i.e. lightness). This lightness adjustment is carried out using the lightness correction curve, similarly to the case in the first embodiment.

The next step is to find the value of Y corresponding to the L* value obtained in S33 (S34). To put it more specifically, the value Yd2 of Yd corresponding to the L*a*b* value is calculated using the equation yd=(L*+16)/116 of Formula 1, similarly to the case of the first embodiment, and the value Y2/Y0 of the expression in Formula 3 is also calculated.

Values of R, G and B are adjusted simultaneously using the value Y/Y0 of Y corresponding to L* value prior to adjustment of the lightness and Y2/Y0 corresponding to the L* value subsequent to adjustment (S35). The values of R. G and B subsequent to adjustment are expressed as R2, G2 and B2, respectively. They are each defined as follows:
R2=R×{(Y2/Y0)/(Y/Y0)}
G2=G×{(Y2/Y0)/(Y/Y0)}
B2=B×{(Y2/Y0)/(Y/Y0)} (Formula 8)

Using the Formula 7 stored in the XYZ/RGB transforming section 38, the calculation control section 31 transforms the R2, G2 and B2 into the values of the XYZ color system (S36). The values transformed into the XYZ color system are expressed as X3/X0, Y3/Y0 and Z3/Z0, respectively.

Further, using the Formula 2 stored in the L*a*b*/XYZ transforming section 34, the calculation control section 31 transforms the values X3/X0, Y3/Y0 and Z3/Z0 back to the L*a*b* values (S37). For this purpose, the X3/X0, Y3/Y0 and Z3/Z0 are transformed into Xd″, Yd″ and Zd″, as shown in the following formula, similarly to the case of the first embodiment.
Xd″=(X3/X0)^{1/3} (X3/X0>0.008856)=(X3/X0)×7.787+16/116 (otherwise)
Yd″=(Y3/Y0)^{1/3} (Y3/Y0>0.008856)=(Y3/Y0)×7.787+16/116 (otherwise)
zd″=(Z3/Z0)^{1/3} (Z3/Z0>0.008856)=(Z3/Z0)×7.787+16/116 (otherwise) (Formula 9)

Then the Xd″, Yd″ and Zd″ are substituted into the Xd, Yd and Zd of the Formula 2 stored in the L*a*b*/XYZ transforming section 34 and is transformed into the L*a*b* values. This procedure provides the L*″, a*″ and b*″ having their lightness and chroma adjusted. The values of the L*″, a*″ and b*″ are transformed using the L*a*b*→CMYK LUT 332 of the proof color printer 4 to find out the C, M, Y and K (S13 in FIG. 6), whereby a device-link color profile 35 is created (S14 in FIG. 6).

The device-link color profile 35 is created using the L*″, a*″ and b*″ obtained from the process shown in FIG. 10. This arrangement allows chroma to be adjusted in response to lightness adjusting amount. In other words, the values of the RGB color system are simultaneously adjusted when the ratio (Y2/Y0)/(Y/Y0) between the Y/Y0 dependent only on the lightness prior to adjustment and Y2/Y0 dependent only on the lightness (L*7) subsequent to adjustment is assumed as the coefficient. Then R2, G2 and B2 are calculated, and are transformed to get L*″, a*″ and b*″; therefore, the a*′ and b*′ indicating chroma are adjusted at the same ratio as the lightness (L* value) adjusting amount.

Similarly to the case of the first embodiment, in addition to adjustment of the lightness, chroma can also be adjusted in response to the adjusting amount. This arrangement allows the output color of the proof color printer 4 to be matched to the output of the printing machine 6 with high precision.

Further, the present embodiment allows lightness and chroma to be adjusted according to the RGB color system corresponding to the human eye sensitivity, and this arrangement ensures high-precision color matching in conformity to the colors recognized by humans.

As shown in FIG. 9, when both the L*a*b*/XYZ transforming section 34 and XYZ/RGB transforming section 38 are incorporated in the configuration, it is also possible to make such arrangements so as to select if adjustment of the lightness and chroma in creating the device-link color profile 35 is to be carried out in the XYZ color system as in the first embodiment or in the RGB color system as in the present embodiment.

The color adjusting method of the present invention can be preferably used in the color matching among image outputting apparatuses where different types of paper is used as in the aforementioned embodiments. In the aforementioned embodiments, the color adjusting method permits adjustment of the differences between the output color on such printing paper as uncoated paper heavily affected by scattering of light and, and the output color on the form made of silver halide photosensitive material where the color proof is outputted. Especially when outputting such a color as blue having a low L* value and a high chroma using a proof color printer, the a* and b* values can be adjusted in response to the L* value adjusting amount, and this ensures more faithful reproduction of the colors of printed material.

The color adjusting method of the present invention described with reference to the first and second embodiment is implemented according to the program that can be executed by the image transforming apparatus of the embodiments. This program is recorded on a computer-readable information recording medium. Such an information recording medium can be any appropriate medium conforming to the aforementioned computer configuration, including such a portable medium as a CD-ROM, floppy (trademark) disk or such a medium mounted on the computer as ROM and HDD. The information recording medium includes any type of information recording medium capable of recording the program.

The aforementioned configuration described in details refers to only an example for the embodiment of the present invention, and is subject to deformation, modification or addition as appropriate, without departing from the spirit of the present invention. In addition to color matching between the printer and proof color printer, the present invention is applicable to the matching of any output colors of a plurality of image outputting apparatuses.

1. A color adjusting method comprising the steps of:
creating a first color profile for each of a first and a second image outputting apparatuses, based on values for a predetermined color system obtained by measuring a color chart outputted with various combinations of values representing intensities of cyan (C), magenta (M), yellow (Y) and black (K) as fundamental colors, the first color profile including:
a first lookup table storing the values of the predetermined color system corresponding to combinations of values for the intensities of the fundamental colors; and
a second lookup table storing combinations of values for the intensities of the fundamental colors corresponding to the values of the predetermined color system;
creating a second color profile based on the first color profile of the first and the second image outputting apparatuses, the second color profile storing combinations of values for intensities of the fundamental colors of the second image outputting apparatus, corresponding to combinations of values for intensities of the fundamental colors of the first image outputting apparatus; and
adjusting by using the second color profile in such a manner that an output color of the second image outputting apparatus matches to that of the first image outputting apparatus;
wherein the color adjusting method further comprising the steps of:
adjusting lightness expressed by values of the predetermined color system obtained from the first lookup table of the first image outputting apparatus; and
adjusting chroma by changing the values of the predetermined color system so as to adjust the chroma in response to the ratio of the lightness before to the lightness after the adjusting lightness step;
wherein, the second color profile is created, based on the values of predetermined color systems having been adjusted in the adjusting lightness step and in the adjusting chroma step.

2. The color adjusting method of claim 1, wherein the predetermined color system is L*a*b* color system, and the adjusting chroma step comprising:
transforming values of the L*a*b* color system before adjustment in the adjusting lightness step, into values of XYZ color system;
transforming L* value of the L*a*b* color system after the adjustment in the adjusting lightness step, into Y value of the XYZ color system;
correcting, for the purpose of adjusting the chroma, the values of X and Z of the XYZ color system before the adjustment in the adjusting lightness step, in response to the ratio of the value Y before the adjustment to the value Y after the adjustment; and
transforming the corrected values X and Z and value Y after the adjustment, into values of the L*a*b* color system.

3. The color adjusting method of claim 1, wherein the predetermined color system is L*a*b* color system, and the adjusting chroma step comprising:
transforming values of the L*a*b* color system before adjustment in the adjusting lightness step, into values of XYZ color system;
transforming values of XYZ color system before the adjustment obtained, into values of RGB color system;
transforming L* value of the L*a*b* color system after the adjustment in the adjusting lightness step, into Y value of the XYZ color system;
correcting, for the purpose of adjusting the chroma, the values the RGB color system before the adjustment in the adjusting lightness step, in response to the ratio of the value Y before the adjustment to the value Y after the adjustment;
transforming the corrected values of the RGB color system
into values of the XYZ color system; and
transforming the transformed values of the XYZ color system into values of the L*a*b* color system.

4. The color adjusting method of claim 1, wherein different types of paper are used between the first and the second image outputting apparatuses.

5. The color adjusting method of claim 1, wherein the first image outputting apparatus is a printing machine, and the second image outputting apparatus is a proof color printer for outputting the color proof.

6. A program for allowing a computer to execute the color adjusting method, the color adjusting method comprising the steps of:
creating a first color profile for each of a first and a second image outputting apparatuses, based on values for a predetermined color system obtained by measuring a color chart outputted with various combinations of values representing intensities of cyan (C), magenta (M), yellow (Y) and black (K) as fundamental colors, the first color profile including:
a first lookup table storing the values of the predetermined color system corresponding to combinations of values for the intensities of the fundamental colors; and
a second lookup table storing combinations of values for the intensities of the fundamental colors corresponding to the values of the predetermined color system;
creating a second color profile based on the first color profile of the first and the second image outputting apparatuses, the second color profile storing combinations of values for intensities of the fundamental colors of the second image outputting apparatus, corresponding to combinations of values for intensities of the fundamental colors of the first image outputting apparatus; and
adjusting by using the second color profile in such a manner that an output color of the second image outputting apparatus matches to that of the first image outputting apparatus;
wherein the color adjusting method further comprising the steps of:
adjusting lightness expressed by values of the predetermined color system obtained from the first lookup table of the first image outputting apparatus; and
adjusting chroma by changing the values of the predetermined color system so as to adjust the chroma in response to the ratio of the lightness before to the lightness after the adjusting lightness step;
wherein, the second color profile is created, based on the values of predetermined color systems having been adjusted in the adjusting lightness step and in the adjusting chroma step.

7. A computer-readable information recording medium, in which the program of claim 6 is recorded.
